(19) United States
(12) Patent Application Publication
(10) Pub. No.: US 2006/0182943 A1
(43) Pub. Date: Aug. 17, 2006

(54) Thermal insulation for underwater components for oil and gas production

(75) Inventor: Thomas Eyhorn, Altusried (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 10/775,463

(22) Filed: Feb. 10, 2004

(30) Foreign Application Priority Data
Feb. 27, 2003 (DE) 103 08 581.5

(51) Int. Cl. B32B 3/00

(52) U.S. Cl. 428/304.4; 428/315.5; 428/318.4

(57) ABSTRACT

Heat insulation for underwater components comprises a heat-insulating molding surrounding the component and a resilient water-resistant envelope surrounding the heat-insulating molding, wherein the heat-insulating molding is a nanoporous, mesoporous or microporous material based on precipitated or pyrogenic silica, arc silica, and/or aerogel.

### BACKGROUND OF THE INVENTION

1. Field of the Invention

The invention relates to a heat insulation for underwater components for oil and gas production.

2. Background Art

Oil and gas production from the sea bed requires a multiplicity of components, such as pipelines, valve systems and other control systems which are installed underwater. The crude oil produced contains components which lead to blockage of the valves and pipes on cooling. Thermal insulation of the underwater components for oil and gas production on the sea bed, in particular complex structures, such as “manifolds”, “Xmas trees”, “templates”, etc., constructed of suitable materials and structures, is therefore necessary. Otherwise, the temperature in the pipes can decrease considerably in the case of regularly occurring breaks in production. If, however, the temperature falls below a certain temperature which is specific for the respective field, hydrate and wax deposits form in the pipes and are complicated and expensive to eliminate. Thermally insulated pipes on the other hand cool down more slowly.

Polymers such as polypropylene, polyethylene, polyurethane, epoxy, and various elastomers which have a low thermal conductivity (about 0.2 W/mK) and also exhibit low weight and good mechanical properties, are preferably used as heat insulation. The heat-insulating properties of these polymers are often improved by addition of hollow spheres, for example of glass, plastic, or ceramic materials, which at the same time also reduces the weight or even generates buoyancy. In general, hollow spheres of different sizes are mixed in in order to increase the degree of filling and to reduce the thermal conductivity, as disclosed in U.S. Pat. No. 6,058,979, directed to subsea pipeline insulation, or U.S. Pat. No. 6,284,809, directed to thermally insulating syntactic foam compositions.

Furthermore, so-called pipe-in-pipe (PIP) systems are used in which the heat insulation is introduced between two concentric structural steel pipes. Open-pore heat insulating materials, e.g. open-cell polymer foams, fiber materials or microporous heat insulations can be accommodated in such systems; such materials ensure better thermal insulation (i.e. lower heat conduction) than the polymers, so that smaller radial coat thicknesses are required. The steel sheath protects the heat insulation from the entry of water and hydrostatic pressure. Occasionally, such PIP systems are also vacuum-insulated, which results in a high performance thermal insulation. GB 2269876 furthermore discloses a process for heat insulation in which a pipeline is mounted in the middle of ceramic hollow microspheres in a resilient envelope. Polyethylene, PVC, polyolefin or glass fiber-reinforced resins and preferably steel are mentioned as resilient materials. In order to avoid losing the heat-insulating effect, the ceramic hollow microspheres must have a breaking strength which is higher than the ambient water pressure if no steel shell is used. This insulation is therefore unsuitable for high water pressure since ceramic hollow microspheres having corresponding high pressure resistance are available only to a limited extent.

The polymer insulations are all limited in their thermal insulation capacity and additionally suffer from quality variation due to the manual application techniques used for their installation. Higher quality standards always incur additional production outlay, i.e. increased costs and longer production times, in particular in the case of complex components.

The higher-quality thermal insulations such as microporous insulating materials and PCM devices have always required a protective outer steel jacket, which can be realized at acceptable costs only for simple round geometries (pipes). Without the steel jacket, it has not been possible to date to prevent the penetration of water into the heat insulation. High hydrostatic pressure also destroys or at least damages the insulation.

### SUMMARY OF THE INVENTION

It is an object of the invention to provide an efficient heat insulation for underwater components which is moreover more economical than known heat insulations for this purpose. This and other objects are achieved by a heat-insulating molding which surrounds the component and a resilient water-resistant envelope which surrounds the heat-insulating molding.

### DETAILED DESCRIPTION OF THE PREFERRED EMBODIMENT(S)

The heat-insulating molding is preferably a nanoporous, mesoporous or microporous material based on precipitated or pyrogenic silica, arc silicas and/or aerogels, most preferably microporous insulating material based on pyrogenic silica.

The insulating material is preferably encased in a sheet, most preferably a plastics sheet. Suitable sheets are single-ply sheets such as polyethylene (PE) sheets or polyamide (PA) sheets, or multi-ply sheets (laminated sheets) such as PE/PA sheets or PE/PA/polypropylene sheets. The sheets can acquire improved impermeability to diffusion by metallization or by a layer of aluminum, in order to minimize the penetration of water and gases, for example, water vapor, even over long periods and at high pressures, e.g. great water depth. Consequently, the heat insulation performance can be kept constant over years.

The interior of the encasing sheet is preferably evacuated, which stabilizes the insulation panel thus obtained and facilitates handling. The evacuation can be carried out in such a way that only a slight vacuum, preferably from 100 to 950 mbar, prevails in the interior of the sheet, but can also be carried out in such a way that a high vacuum, preferably less than 100 mbar, more preferably less than 10 mbar, prevails in the interior of the sheet. Highly evacuated systems, such as, for example, vacuum insulation panels, are thus also suitable as heat-insulating moldings. These can optionally be provided with getters in order to minimize a pressure increase in the interior of the panels over years. The insulation thus encased may be from 3 to 50 mm thick, preferably 5-20 mm. The insulation preferably has incisions at regular intervals, with the result that the heat insulation panel is flexible and can be wound around different curves. Useful heat insulation panels are known and are disclosed, for example, in U.S. Pat. No. 6,110,310 (EP-B-0937939). Explicit reference to the content of this patent will be made with respect to possible embodiments of the heat-insulating layer. U.S. Pat. No. 6,110,310 is hereby incorporated by reference.

It is also possible to arrange the individual insulation panels as one layer or a plurality of layers around the component, it being possible to arrange the layers so that there is an offset at the abutment points, and then to provide this arrangement with a resilient water-resistant envelope.

The resilient water-resistant envelope preferably has a wall thickness of 1-5 mm in order to be able to absorb the mechanical loads occurring during installation and in operation without the inner sheet being damaged.

The resilient water-resistant envelope preferably has a deformability which permits compression of the inner panels under hydrostatic pressure without tears in the envelope. Materials having an elongation at break of from 100 to 1,000% are preferable as the resilient water-resistant envelope. Suitable materials are known, for example, as covering materials for cold isostatic pressing. The resilient water-resistant envelope is preferably an elastomer or a resilient thermoplastic, such as polyurethane, Vulkollan®, PVC, rubber or another correspondingly resilient material.

The resilient water-resistant envelope preferably has a waterproof seal which prevents penetration of water into the elastomer envelope. This seal should not tear open even on mechanical deformation, in order thus to render it less prone to water penetration. The seal can, for example, be welded, clamped or adhesively bonded.

The heat insulation moldings (insulation panels) are prefabricated and placed around the components to be insulated. A flexible design, preferably having incisions, permits an exact fit around the contour of the component. Preferably, at least two layers of heat insulation moldings are applied in order to cover heat bridges at abutments and incisions and to improve the overall efficiency. The water-resistant envelope is then pulled on and sealed.

After fastening of the inventive heat insulation to the components, for example by means of straps or adhesive bonding, the component is installed underwater, the resultant water pressure compacting the insulation. This reduces the wall thickness but the stability simultaneously increases, so that the final thickness and shape are reached at the water depth during operation. The insulation is now so rigid that it remains shaped around the component substantially independently, and the original fastening serves only for additional securing. Furthermore, the individual plys of the heat-insulating moldings combine to form a stable laminate, resulting in a heat insulation element adapted to the component.

The major advantage of the insulation of the invention, in addition to the outstanding heat insulation, is the simple production of the sheathed components. In corresponding experiments, it has in fact surprisingly been found that, even at very high pressures, in the case of microporous insulation, it is possible to dispense with a pressure-resistant sheath without the microporous insulating material being destroyed. The insulation effect is reduced owing to the increased density but is still very good. A pressure of 300 bar, equivalent to a water depth of about 3,000 m, compacts the microporous insulation so that the density is about 1,000 kg/m³ and the thermal conductivity increases from about 0.02 to about 0.06 W/mK. In comparison, the best polymeric insulations have a thermal conductivity value of more than 0.13 W/mK. The insulation properties of the polymer insulations are therefore still substantially poorer. The outer resilient envelope serves for fixing the material on the component and preventing the admission of water since the heat insulation is in direct contact with the water, increasing performance and durability as a result.

The present invention thus for the first time permits highly efficiency heat insulation of complex underwater components without a protective steel sheath at pressures of above 10 bar, preferably 50 bar, and most preferably 100 bar.

The invention furthermore relates to a method for the heat insulation of underwater components in oil and gas production, wherein an underwater component is surrounded with a heat-insulating material and this material is provided with a resilient, water-resistant envelope.

The heat-insulating material is preferably a microporous material. Preferably, the microporous material is first encased within a sheet at reduced pressure, which facilitates the handling of the material and provides protection from moisture even before the application to the component.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. Thermal insulation for an underwater component comprising, a heat-insulating molding surrounding the component and a resilient water-resistant envelope surrounding the heat-insulating molding, wherein the heat-insulating molding is a nanoporous, mesoporous or microporous material based on precipitated or pyrogenic silica, arc silica and/or aerogel.

2. The heat insulation of claim 1, wherein the microporous insulation material is present encased within a sheet.

3. The heat insulation of claim 2, wherein the sheet is a single-ply sheet such as, for example, a polyethylene (PE) sheet or a polyamide (PA) sheet or a multiply sheet (laminated sheet), such as, for example, a PE/PA sheet or a PE/PA/polypropylene sheet.

4. The heat insulation material of claim 3 wherein said single-ply sheet comprises polyethylene or polyamide.

5. The heat insulation of claim 3, wherein said multi-ply sheet comprises polyethylene/polyamide or polyethylene/polyamide/polypropylene.

6. The heat insulation of claim 2, wherein the sheet exhibits reduced permeability to fluids and is metallized or contains a metal layer to reduce permeability.

7. The heat insulation of claim 2, wherein the interior of the sheet is evacuated.

8. The heat insulation of claim 1, wherein the resilient water-resistant envelope is a material having an elongation at break of from 100 to 1,000%.

9. The heat insulation of claim 1, wherein the resilient water-resistant envelope is an elastomer or a resilient thermoplastic.

10. A method for the thermal insulation of an underwater component in oil and gas production, comprising surrounding the underwater component by a microporous material and is providing a resilient, water-resistant envelope, around said microporous material.

11. A thermally insulated underwater component, prepared by the method of claim 10.

12. The thermally insulated component of claim 11, wherein said microporous material is encased within a polymer sheath, said microporous material having a plurality of incisions therein which render it flexible and conformable to said underwater component.

13. The thermally insulated component of claim 12, wherein said microporous material comprises pyrogenic silica.

14. The thermally insulated component of claim 10, wherein no protective steel sheath surrounds said resilient water-resistant envelope.

15. The thermally insulated component of claim 10, wherein said microporous material has a density at 300 bar pressure of about 1,000 Kg/m³ and a thermal conductivity of about 0.06 W/mK or less.
